(19) United States
(12) Patent Application Publication
(10) Pub. No.: US 2024/0177934 A1
(43) Pub. Date: May 30, 2024

(54) MULTILAYER ELECTRONIC COMPONENT

(71) Applicant: SAMSUNG ELECTRO-MECHANICS CO., LTD., Suwon-si (KR)

(72) Inventors: Yoona PARK, Suwon-si (KR); Ji Hye HAN, Suwon-si (KR); Kangha LEE, Suwon-si (KR); Chul Seung LEE, Suwon-si (KR)

(73) Assignee: SAMSUNG ELECTRO-MECHANICS CO., LTD., Suwon-si (KR)

(21) Appl. No.: 18/368,771

(22) Filed: Sep. 15, 2023

(30) Foreign Application Priority Data
Nov. 30, 2022 (KR) 10-2022-0164412

(51) Int. Cl. H01G 4/30; H01G 4/008; H01G 4/012; H01G 4/12

(52) U.S. Cl. CPC H01G 4/30; H01G 4/008; H01G 4/012; H01G 4/12

(57) ABSTRACT

A multilayer electronic component, in which a first external electrode may include a 1-2-th electrode layer including glass, and a 1-3-th electrode layer disposed on the first and second surfaces and a second external electrode may include a 2-2-th electrode layer including glass, and a 2-3-th electrode layer disposed on the first and second surfaces. In cross sections of the first and second external electrodes in the first and second directions, when an area fraction occupied by glass in the 1-2-th electrode layer is S1-2, an area fraction occupied by glass in the 1-3-th electrode layer is S1-3, an area fraction occupied by glass in the 2-2-th electrode layer is S2-2, and an area fraction occupied by glass in the 2-3-th electrode layer is S2-3, S1-2≥15%, S1-2≥S1-3, S2-2≥15%, S2-2>S2-3 are satisfied, thereby preventing cracks and improving moisture resistance reliability.

### CROSS-REFERENCE TO RELATED APPLICATION (S)

This application claims benefit of priority to Korean Patent Application No. 10-2022-0164412 filed on Nov. 30, 2022 in the Korean Intellectual Property Office, the disclosure of which is incorporated herein by reference in its entirety.

### TECHNICAL FIELD

The present disclosure relates to a multilayer electronic component.

### BACKGROUND

A Multilayer Ceramic Capacitor (MLCC), a multilayer electronic component, is a chip-type capacitor mounted on the printed circuit boards of various electronic products including video display devices such as liquid crystal displays (LCDs) and plasma display panels (PDPs), computers, smartphones, and mobile phones, to serve to charge or discharge electricity.

Multilayer ceramic capacitors may be used as components of various electronic devices due to the advantages of being small, high capacitance guaranteed, and easy to mount. As various electronic devices such as computers and mobile devices are miniaturized and the high-powered, demand for miniaturization and high capacitance multilayer ceramic capacitors is increasing. In accordance with the miniaturization and high capacitance trend of multilayer ceramic capacitors, the importance of increasing the capacitance per unit volume of multilayer ceramic capacitors is increasing.

Recently, with the advent of foldable smartphones and wearable devices, multilayer ceramic capacitors are required to have high resistance to external stress caused by deformation of a substrate or the like. If the multilayer ceramic capacitor does not have resistance to stress, moisture resistance and high-temperature reliability may deteriorate due to cracks.

To prevent such a problem, a method of lowering the content of glass included in external electrodes may be considered. When the content of glass included in the external electrode is small and an external stress exceeding the deformation range is applied, the external electrode disposed on the mounting surface may be peeled off, thereby preventing cracks from occurring on the body.

However, when the content of glass included in the external electrode is lowered, the density of the external electrode may be lowered, and accordingly, external moisture may penetrate into internal electrodes through pores formed in the external electrode, deteriorating reliability of the multilayer ceramic capacitor.

Therefore, there is a need for research into the structure of an external electrode capable of improving moisture resistance reliability of a multilayer ceramic capacitor while preventing cracks from occurring in the body due to external stress.

### SUMMARY

An aspect of the present disclosure is to prevent cracks from occurring in the body due to external stress.

An aspect of the present disclosure is to improve moisture resistance reliability of multilayer electronic components.

An aspect of the present disclosure is to provide a multilayer electronic component having excellent bonding strength between internal electrodes and external electrodes.

According to an aspect of the present disclosure, a multilayer electronic component includes a body including a dielectric layer and first and second internal electrodes alternately disposed with the dielectric layer interposed therebetween, and having a first surface and a second surface opposing each other in a first direction, a third surface and a fourth surface connected to the first and second surfaces and opposing each other in a second direction, and a fifth surface and a sixth surface connected to the first to fourth surfaces and opposing each other in a third direction; a first external electrode including a 1-1-th electrode layer disposed on the third surface, a 1-2-th electrode layer disposed on the 1-1-th electrode layer and including glass, and a 1-3-th electrode layer disposed on the first and second surfaces and connected to the 1-2-th electrode layer; and a second external electrode including a 2-1-th electrode layer disposed on the fourth surface, a 2-2-th electrode layer disposed on the 2-1-th electrode layer and including glass, and a 2-3-th electrode layer disposed on the first and second surfaces and connected to the 2-2-th electrode layer. In cross sections of the first and second external electrodes in the first and second directions, when an area fraction occupied by glass in the 1-2-th electrode layer is S1-2, an area fraction occupied by glass in the 1-3-th electrode layer is S1-3, an area fraction occupied by glass in the 2-2-th electrode layer is S2-2, and an area fraction occupied by glass in the 2-3-th electrode layer is S2-3, S1-2≥15%, S1-2>S1-3, S2-2≥15% and S2-2>S2-3 are satisfied.

According to an aspect of the present disclosure, a multilayer electronic component includes a body including a dielectric layer and first and second internal electrodes alternately disposed with the dielectric layer interposed therebetween, and having a first surface and a second surface opposing each other in a first direction, a third surface and a fourth surface connected to the first and second surfaces and opposing each other in a second direction, and a fifth surface and a sixth surface connected to the first to fourth surfaces and opposing each other in a third direction; a first external electrode including a 1-1-th electrode layer disposed on the third surface, a 1-2-th electrode layer disposed on the 1-1-th electrode layer, and a 1-3-th electrode layer disposed on the first and second surfaces and connected to the 1-2-th electrode layer; and a second external electrode including a 2-1-th electrode layer disposed on the fourth surface, a 2-2-th electrode layer disposed on the 2-1-th electrode layer, and a 2-3-th electrode layer disposed on the first and second surfaces and connected to the 2-2-th electrode layer. The 1-1-th electrode layer and the 2-1-th electrode layer are plating layers each containing at least one of Cu, Ni, Cr, Sn, and Pd, the 1-2-th electrode layer and the 2-2-th electrode layer each include glass, a content of glass included in the 1-2-th electrode layer is greater than a content of glass included in the 1-3-th electrode layer, and a content of glass included in the 2-2-th electrode layer is greater than a content of glass included in the 2-3-th electrode layer.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment;

FIG. 2 is a cross-sectional view schematically illustrating a section taken along line I-I′ of FIG. 1;

FIG. 3 is a cross-sectional view schematically illustrating a section taken along line II-II′ of FIG. 1;

FIG. 4 is an exploded perspective view schematically illustrating an exploded body of a multilayer electronic component according to an embodiment;

FIG. 5 is an enlarged view of region K1 of FIG. 2;

FIG. 6 is an enlarged view of region K2 of FIG. 2;

FIG. 7 is an enlarged view of region K3 of FIG. 2; and

FIGS. 8 to 12 are modified examples of FIG. 2.

### DETAILED DESCRIPTION

Hereinafter, embodiments of the present disclosure will be described with reference to detailed embodiments and accompanying drawings. However, the embodiments of the present disclosure may be modified in many different forms, and the scope of the present disclosure is not limited to the embodiments described below. In addition, the embodiments of the present disclosure are provided to more completely describe the present disclosure to those skilled in the art. Therefore, the shape and size of elements in the drawings may be exaggerated for clearer explanation, and elements indicated by the same reference numerals in the drawings are the same elements.

In addition, to clearly describe the present disclosure in the drawings, parts irrelevant to the description are omitted, and the size and thickness of each component illustrated in the drawings are arbitrarily illustrated for convenience of description, and thus, the present disclosure is not necessarily limited to the illustrated embodiment. Also, components having the same function within the scope of the same concept are described using the same reference numerals. Furthermore, throughout the specification, when a certain component is said to “include,” it means that it may further include other components without excluding other components unless otherwise stated.

In the drawings, the first direction may be defined as the thickness (T) direction, the second direction may be defined as the length (L) direction, and the third direction may be defined as the width (W) direction.

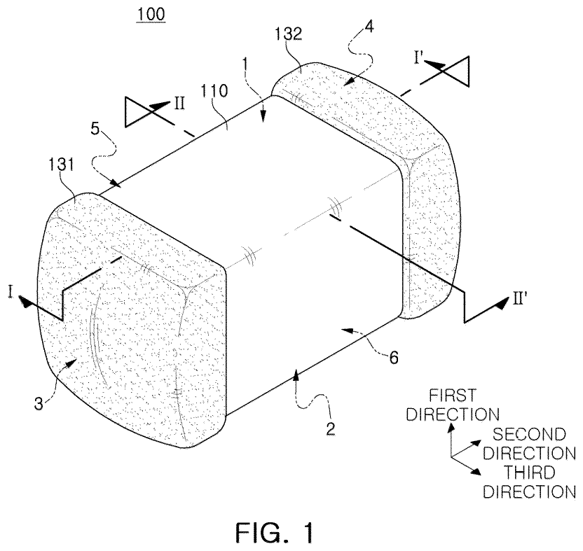

FIG. 1 is a perspective view schematically illustrating a multilayer electronic component according to an embodiment.

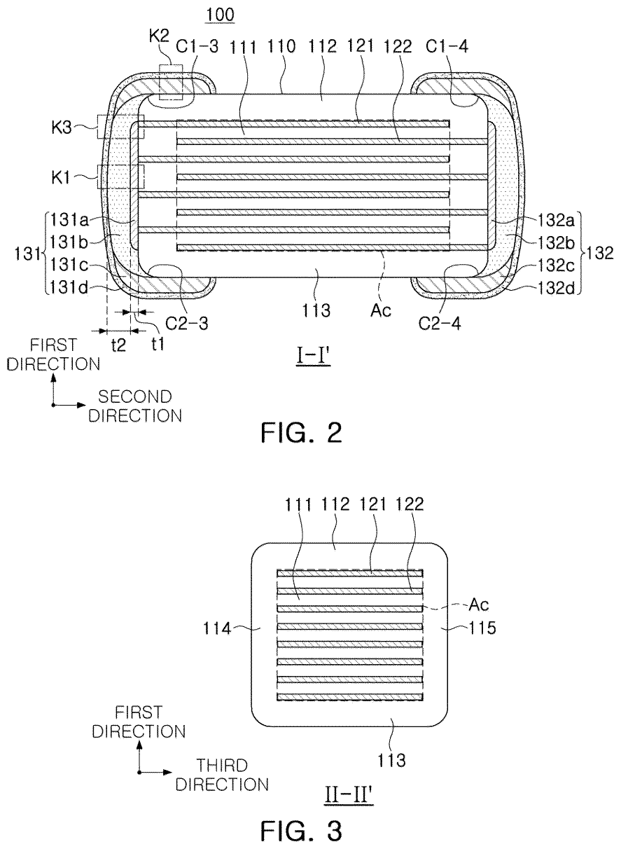

FIG. 2 is a cross-sectional view schematically illustrating a section taken along line I-I′ of FIG. 1.

FIG. 3 is a cross-sectional view schematically illustrating a section taken along line II-II′ of FIG. 1.

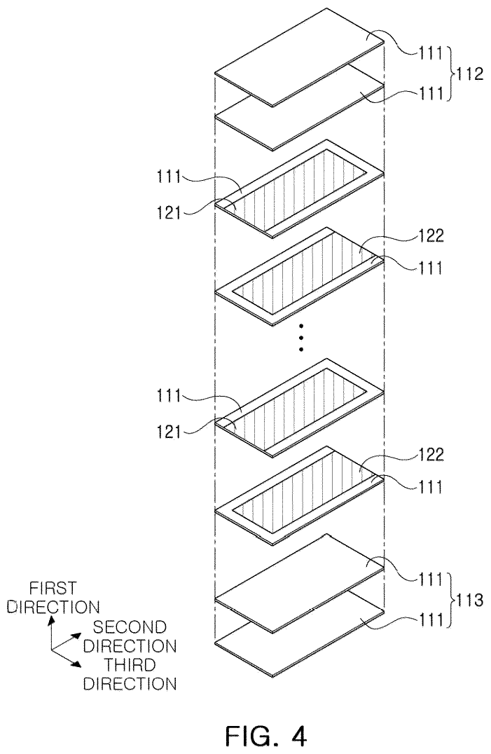

FIG. 4 is an exploded perspective view schematically illustrating an exploded body of a multilayer electronic component according to an embodiment.

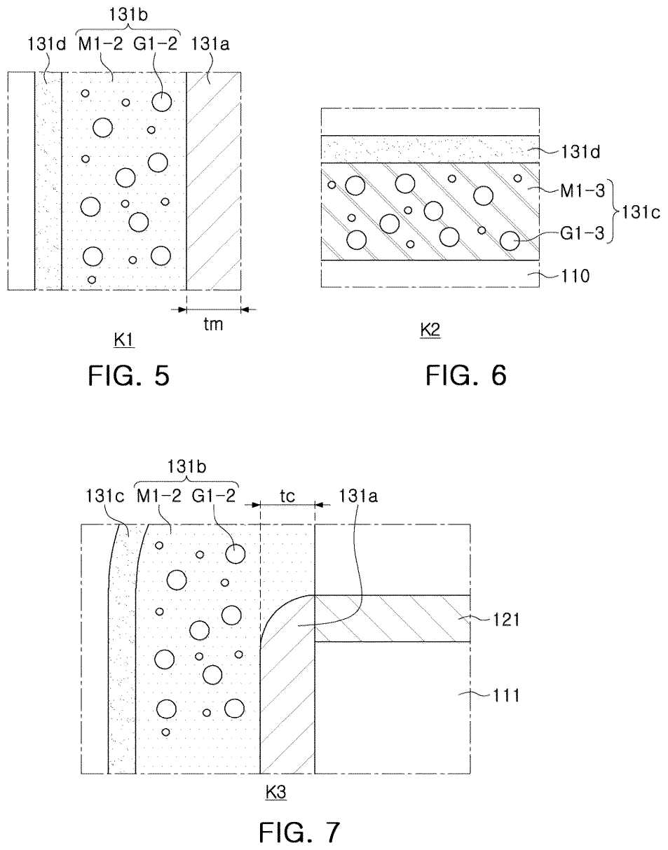

FIG. 5 is an enlarged view of region K1 of FIG. 2.

FIG. 6 is an enlarged view of region K2 of FIG. 2.

FIG. 7 is an enlarged view of region K3 of FIG. 2.

Referring to FIGS. 1 to 7, a multilayer electronic component 100 according to an embodiment may include a body 110, including a dielectric layer 111 and first and second internal electrodes 121 and 122 alternately disposed with the dielectric layer interposed therebetween and having first and second surfaces 1 and 2 opposing each other in the first direction, third and fourth surfaces 3 and 4 connected to the first and second surfaces and opposing each other in the second direction, and fifth and sixth surfaces 5 and 6 connected to the first to fourth surfaces and opposing each other in the third direction, a first external electrode 131 including a 1-1-th electrode layer 131a disposed on the third surface, a 1-2-th electrode layer 131b disposed on the 1-1-th electrode layer and including glass, and a 1-3-th electrode layer 131c disposed on the first and second surfaces and connected to the 1-2-th electrode layer, and a second external electrode 132 including a 2-1-th electrode layer 132a disposed on the fourth surface, a 2-2-th electrode layer 132b disposed on the 2-1-th electrode layer and including glass, and a 2-3-th electrode layer 132c disposed on the first and second surfaces and connected to the 2-2-th electrode layer. In the cross sections of the first and second external electrodes in the first and second directions, when the area fraction occupied by glass in the 1-2-th electrode layer 131b is S1-2, the area fraction occupied by the glass in the 1-3-th electrode layer 131c is S1-3, the area fraction occupied by glass in the 2-2-th electrode layer 132b is S2-2, and the area fraction occupied by glass in the 2-3-th electrode layer 132c is S2-3; S1-2≥15%, S1-2>S1-3, S2-2≥15%, and S2-2>S2-3 may be satisfied.

As described above, cracks may occur in the body of the multilayer electronic component due to external stress such as deformation of the substrate, and thus moisture resistance and high-temperature reliability of the multilayer electronic component may be deteriorated. To prevent this problem, in the case in which the content of glass included in the external electrode is lowered, the density of the external electrode is lowered and external moisture may penetrate through the exposed surface of the internal electrode.

Meanwhile, in the case of the multilayer electronic component 100 according to an embodiment of the present disclosure, by satisfying S1-2≥15%, S1-2>S1-3, S2-2≥15% and S2-2>S2-3, external moisture may be prevented from penetrating into the internal electrodes 121 and 122 through the third and fourth surfaces, and in a case in which an external stress exceeding the deformation range is applied, the 1-3-th electrode layer 131c and the 2-3-th electrode layer 132c are peeled off from the body 110, thereby preventing cracks from occurring by relieving the stress applied to the body 110.

Hereinafter, respective components included in the multilayer electronic component 100 according to an embodiment will be described in more detail.

Although the detailed shape of the body 110 is not particularly limited, as illustrated, the body 110 may have a hexahedral shape or a shape similar thereto. Due to shrinkage of the ceramic powder included in the body 110 during the sintering process or polishing of the corners, the body 110 does not have a hexahedral shape with perfect straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

The body 110 may include a 1-3-th corner C1-3 connecting the first surface and the third surface, a 1-4-th corner C1-4 connecting the first surface and the fourth surface, a 2-3-th corner C2-3 connecting the second and third surfaces, and a 2-4-th corner C2-4 connecting the second and fourth surfaces. In addition, the body 110 may include a 1-5-th corner connecting the first surface and the fifth surface, a 1-6-th corner connecting the first surface and the sixth surface, a 2-5-th corner connecting the second surface and the fifth surface, and a 2-6-th corner connecting the second surface and the sixth surface. The corner may have a round shape by rounding the corner connecting respective surfaces of the body 110 by performing a separate process. The first to sixth surfaces of the body 110 may be substantially flat surfaces, and non-flat areas may be viewed as corners.

In the body 110, dielectric layers 111 and internal electrodes 121 and 122 may be alternately stacked. The plurality of dielectric layers 111 forming the body 110 are in a sintered state, and a boundary between adjacent dielectric layers 111 may be unified to the extent that it is difficult to confirm without using a scanning electron microscope (SEM).

The dielectric layer 111 may be formed by preparing a ceramic slurry containing ceramic powder, an organic solvent and a binder, applying and drying the slurry on a carrier film to prepare a ceramic green sheet, and sintering the ceramic green sheet. The ceramic powder is not particularly limited as long as sufficient capacitance may be obtained, but, for example, barium titanate-based (BaTiO₃)-based powder may be used.

The average thickness of the dielectric layer does not need to be particularly limited. On the other hand, to obtain miniaturization and high capacitance of the multilayer electronic component 100, the thickness of the dielectric layer 111 should be thinned to increase the number of stacked layers, but, as the thickness of the dielectric layer 111 becomes thinner, cracks may easily occur in the body of the multilayer electronic component due to external stress. Thus, moisture resistance and high-temperature reliability of the multilayer electronic component may be deteriorated.

Meanwhile, in the case of a multilayer electronic component according to an embodiment of the present disclosure, by satisfying S1-2≥15%, S1-2>S1-3, S2-2≥15%, and S2-2>S2-3, external moisture may be prevented from penetrating into the internal electrodes 121 and 122 through the third and fourth surfaces, and when an external stress exceeding the deformation range is applied, the 1-3-th electrode layer 131c and the 2-3-th electrode layer 132c are peeled off from the body 110, thereby preventing cracks from occurring by relieving stress applied to the body 110. Accordingly, even when the average thickness of the dielectric layer 111 is 0.4 μm or less, the moisture resistance and high temperature reliability of the multilayer electronic component may be secured.

In this case, the average thickness of the dielectric layer may refer to the average thickness of the dielectric layer 111 disposed between the internal electrodes 121 and 122. The average thickness of the dielectric layer may be measured by scanning the cross section of the body 110 in the first and second directions with a scanning electron microscope (SEM) at a magnification of 10,000. In more detail, an average value may be measured by measuring thicknesses at a plurality of points of one dielectric layer 111, for example, at 30 points equally spaced in the second direction. The 30 equally spaced points may be designated in a capacitance forming portion Ac to be described later. In addition, when the average value is measured by extending this average value measurement to 10 dielectric layers 111, the average thickness of the dielectric layer 111 may be further generalized.

The internal electrodes 121 and 122 may be alternately disposed with the dielectric layer 111. For example, the first internal electrode 121 and the second internal electrode 122, which are a pair of electrodes having different polarities, may be disposed to face each other, with the dielectric layer 111 interposed therebetween. The plurality of first internal electrodes 121 and the plurality of second internal electrodes 122 may be electrically separated from each other by the dielectric layer 111 disposed therebetween.

The plurality of first internal electrodes 121 may be respectively spaced apart from the fourth surface 4 and connected to the third surface 3. In addition, the plurality of second internal electrodes 122 may be respectively spaced apart from the third surface 3 and connected to the fourth surface 4.

The conductive metal included in the internal electrodes 121 and 122 may be at least one of nickel (Ni), copper (Cu), palladium (Pd), silver (Ag), gold (Au), platinum (Pt), tin (Sn), tungsten (W), titanium (Ti) and alloys thereof, but the present disclosure is not limited thereto.

The internal electrodes 121 and 122 may be formed by applying a conductive paste for internal electrodes containing a conductive metal to a predetermined thickness on a ceramic green sheet and sintering the same. A screen-printing method or a gravure printing method may be used as a printing method of the conductive paste for internal electrodes, but the present disclosure is not limited thereto.

The average thickness of the internal electrode does not need to be particularly limited. In this case, the thickness of the internal electrodes 121 and 122 may refer to the size of the internal electrodes 121 and 122 in the first direction. On the other hand, in the case of a multilayer electronic component according to an embodiment of the present disclosure, by satisfying S1-2≥15%, S1-2>S1-3, S2-2≥15% and S2-2>S2-3, even when the average thickness of the internal electrodes 121 and 122 is 0.4 μm or less, the moisture resistance and high temperature reliability of the multilayer electronic component may be secured.

In this case, the average thickness of the internal electrodes may be measured by scanning the cross section of the body 110 in the first and second directions with a scanning electron microscope (SEM) at a magnification of 10,000. In more detail, the average value may be measured by measuring the thicknesses at a plurality of points of one internal electrode 121 or 122, for example, at 30 points equally spaced in the second direction. The 30 equally spaced points may be designated in the capacitance forming portion Ac to be described later. In addition, if the average value is measured by extending this average value measurement to 10 internal electrodes 121 and 122, the average thickness of the internal electrodes 121 and 122 may be further generalized.

The body 110 may include the capacitance forming portion (Ac) which is disposed inside the body 110 and in which capacitance is formed by including a plurality of first internal electrodes 121 and a plurality of second internal electrodes 122 and facing each other with the dielectric layer 111 interposed therebetween, and a first cover portion 112 and a second cover portion 113 disposed on both end surfaces of the capacitance forming portion Ac facing each other in the first direction. The cover portions 112 and 113 may basically serve to prevent damage to the internal electrodes due to physical or chemical stress. The cover portions 112 and 113 may have the same configuration as the dielectric layer 111 except that they do not include internal electrodes.

The average thickness of the cover portion does not need to be particularly limited. However, the average thickness of the cover portion may be 20 μm or less for miniaturization and high capacitance of the multilayer electronic component. As described above, even when the average thickness of the cover portion is 20 μm or less, reliability of the multilayer electronic component 100 may be secured by satisfying S1-2≥15%, S1-2>S1-3, S2-2≥15%, and S2-2>S2-3.

The average thickness of the cover portion refers to the average thickness of each of the first cover portion 112 and the second cover portion 113. The average thickness of the cover portions 112 and 113 may refer to the average size of the cover portions 112 and 113 in the first direction, and may be an average value of sizes in the first direction measured at five equally spaced points in the cross section of the body 110 in the first and second directions.

The body 110 may include margin portions 114 and 115 disposed on both end surfaces of the capacitance forming portion Ac facing each other in the third direction. For example, the margin portions 114 and 115 may refer to regions between both ends of the internal electrodes 121 and 122 and the boundary surface of the body 110 in the cross-section of the body 110 cut in the first and third directions. In this case, the margin portion may include a first margin portion 114 disposed on the fifth surface 5 of the body 110 and a second margin portion 115 disposed on the sixth surface 6 of the body 110.

The margin portions 114 and 115 may include the same material as the dielectric layer 111 except that the internal electrodes 121 and 122 are not included. The margin portions 114 and 115 may basically serve to prevent damage to the internal electrodes 121 and 122 due to physical or chemical stress.

The margin portions 114 and 115 may be formed by coating and sintering a conductive paste for internal electrodes on the ceramic green sheet, except where the margin portion is to be formed. Alternatively, to suppress the level difference caused by the internal electrodes 121 and 122, a single dielectric layer or two or more dielectric layers are laminated on both end surfaces of the capacitance forming portion Ac facing each other in the third direction, thereby forming the margin portions 114 and 115.

The average thickness of the margin portions 114 and 115 does not need to be particularly limited. However, the average thickness of the margin portions 114 and 115 may be 20 μm or less for miniaturization and high capacitance of the multilayer electronic component. As described above, even when the average thickness of the margin portions 114 and 115 is 20 μm or less, moisture resistance reliability and high-temperature reliability of the multilayer electronic component 100 may be secured by satisfying S1-2≥15%, S1-2>S1-3, S2-2≥15%, and S2-2>S2-3.

The average thickness of the margin portions 114 and 115 refers to the average thickness of each of the first margin portion 114 and the second margin portion 115. The average thickness of the margin portions 114 and 115 may refer to the average size of the margin portions 114 and 115 in the third direction, and may be an average value of sizes in the third direction measured at five equally spaced points in the cross section of the body 110 in the first and third directions.

The external electrodes 131 and 132 may be disposed on the third and fourth surfaces 3 and 4 of the body 110, and may include a first external electrode 131 and a second external electrode 132 connected to the plurality of first internal electrodes 121 and the plurality of second internal electrodes 122 respectively.

The first external electrode 131 may include a 1-1-th electrode layer 131a disposed on the third surface, a 1-2-th electrode layer 131b disposed on the 1-1-th electrode layer, a 1-3-th electrode layer 131c disposed on the first and second surfaces and connected to the 1-2-th electrode layer, and a 1-4-th electrode layer 131d disposed on the 1-2-th electrode layer and extending onto the 1-3-th electrode layer. On the other hand, the 1-3-th electrode layer 131c may also be disposed on the fifth and sixth surfaces.

The second external electrode 132 may include a 2-1-th electrode layer 132a disposed on the fourth surface, a 2-2-th electrode layer 132b disposed on the 2-1-th electrode layer, a 2-3-th electrode layer 132c disposed on the first and second surfaces and connected to the 2-2-th electrode layer, and a 2-4-th electrode layer 132d disposed on the 2-2-th electrode layer and extending onto the 2-3-th electrode layer. On the other hand, the 2-3-th electrode layer 132c may also be disposed on the fifth and sixth surfaces.

The 1-1-th electrode layer 131a, the 1-2-th electrode layer 131b, the 1-3-th electrode layer 131c, the 2-1-th electrode layer 132a, the 2-2-th electrode layer 132b, and the 2-3-th electrode layer 132c may each include a metal, and the 1-2-th electrode layer 131b and the 2-2-th electrode layer 132b may include glass. The glass may include, for example, at least one oxide among Ba, Ca, Zn, Al, B, and Si, but the present disclosure is not limited thereto. The glass included in the 1-2-th electrode layer 131b and the 2-2-th electrode layer 132b fills the pores during the sintering process, thereby serving to improve the density of the 1-2-th electrode layer 131b and the 2-2-th electrode layer 132b.

According to an embodiment, in first and second direction cross sections of the first and second external electrodes 131 and 132, the area fraction (S1-2) occupied by glass in the 1-2-th electrode layer 131b and the area fraction (S2-2) occupied by the glass in the 2-2-th electrode layer 132b may each be 15% or more. When the S1-2 and S2-2 are 15% or more, density of the 1-2-th electrode layer 131b and 2-2-th electrode layer 132b may be improved to effectively prevent external moisture from penetrating into the internal electrodes 121 and 122 through the third and fourth surfaces. If the S1-2 and S2-2 are less than 15%, external moisture penetrates into the internal electrodes 121 and 122 through pores formed in the 1-2-th electrode layer 131b and the 2-2-th electrode layer 132b of which density is reduced, and moisture resistance reliability of the multilayer electronic component may deteriorate. The upper limits of S1-2 and S2-2 do not need to be particularly limited, but may be, for example, 40% or less.

According to an embodiment of the present disclosure, the area fraction occupied by glass in the 1-2-th electrode layer 131b may be greater than the area fraction occupied by glass in the 1-3-th electrode layer 131c (S1-2>S1-3), and the area fraction occupied by glass in the 2-2-th electrode layer 132b may be greater than the area fraction occupied by glass in the 2-3-th electrode layer 132c (S2-2>S2-3). The 1-3-th electrode layer 131c and the 2-3-th electrode layer 132c having a relatively low area fraction of glass may be easily peeled-off from the body 110 when an external stress exceeding the deformation range is applied. As a result, stress applied to the body 110 is alleviated, and cracks may be prevented from occurring in the body 110.

In the case of S1-3 and S2-3, for example, S1-3≤14% and S2-3≤14% may be satisfied, and in this case, the effect of relieving stress applied to the body 110 and preventing cracks may be significant.

On the other hand, the lower limits of S1-3 and S2-3 do not need to be particularly limited, and may be greater than 0% to secure bonding strength with the first, second, fifth and sixth surfaces of the body 110, but the present disclosure is not limited thereto. For example, S1-3 and S2-3 may be 0%. When S1-3 and S2-3 are 0%, the 1-3-th electrode layer 131c and the 2-3-th electrode layer 132c may be preferably formed using an electrolytic plating method, an electroless plating method, a sputtering method, a vacuum deposition method, and/or a chemical vapor deposition method.

S1-2, S1-3, S2-2, and S2-3 may each refer to the area ratio of the area in which the glass is disposed to the total area of the area in which the metal is disposed and the area in which the glass is disposed, and may be expressed as Equation 1 below.

S(%)=((area of the region where glass is disposed)/((area of region where metal is disposed)+(area of region where glass is disposed)))×100, where S is S1-2,S1-3,S2- 2,S2-3 [Equation 1]

For example, referring to FIG. 5, S1-2 may refer to the area ratio (%) of the region where the 1-2-th glass (G1-2) is disposed, with respect to the total area of the region where the 1-2-th metal M1-2 is disposed and the region where the 1-2-th glass G1-2 is disposed, in the 1-2-th electrode layer 131b. Also, referring to FIG. 6, S1-3 may refer to the area ratio (%) of the region where the 1-2-th glass (G1-2) is disposed with respect to the total area of the region where the 1-3-th metal M1-3 is disposed and the region where the 1-3-th glass G1-3 is disposed in the 1-3-th electrode layer 131c.

The region where the metal is disposed and the region where the glass is disposed may be distinguished from each other by obtaining images obtained by taking cross sections of the first and second external electrodes 131 and 132 in the first and second directions cut at the center of the body 110 in the third direction with a scanning electron microscope (SEM) at a magnification of 5000 times or more and then by analyzing components of the images by energy dispersive spectroscopy (EDS). For example, in the cross sections of the first and second external electrodes 131 and 132 in the first and second directions, the region in which at least one of elements constituting the glass, for example, at least one of Ba, Ca, Zn, Al, B, and Si, is detected may be determined as the region where the glass is disposed, and therefore, the area fraction of the glass may be measured. In addition, the region where the metal is disposed and the region where the glass is disposed may have different colors or shades in images taken with a scanning electron microscope (SEM), and the area fraction of glass may be measured therefrom.

On the other hand, as illustrated in FIGS. 5 and 6, the S1-2 is measured in the central region of the 1-2-th electrode layer 131b in the first direction, and the S1-3 may be measured in the central region of the 1-3-th electrode layer 131c in the second direction. From the same point of view, the S2-2 is measured in the central region of the 2-2-th electrode layer 132b in the first direction, and the S2-3 may be measured in the central region of the 2-3-th electrode layer 132c in the second direction.

The 1-1-th electrode layer 131a and the 2-1-th electrode layer 132a may serve to connect the internal electrodes 121 and 122 and the external electrodes 131 and 132. The 1-1-th electrode layer 131a and the 2-1-th electrode layer 132a may be substantially formed of metal. In this case, the fact that the 1-1-th electrode layer 131a and the 2-1-th electrode layer 132a are substantially formed of metal means that the area fraction of the metal included in the 1-1-th electrode layer 131a and the 2-1-th electrode layer 132a is 99% or more, and the area fraction of glass is less than 1%.

In more detail, the 1-1-th electrode layer 131a and the 2-1-th electrode layer 132a may not include glass. Since the area fraction of glass is relatively high in the 1-2-th electrode layer 131b and the 2-2-th electrode layer 132b, in the case of direct contact with the internal electrodes 121 and 122, connectivity between the internal electrodes 121 and 122 and the external electrodes 131 and 132 may deteriorate. On the other hand, according to an embodiment of the present disclosure, a 1-1-th electrode layer 131a and a 2-1-th electrode layer 132a connected to the internal electrodes 121 and 122 are included, and the 1-1-th electrode layer and the 2-1-th electrode layer do not contain glass, and therefore, connectivity between the internal electrodes 121 and 122 and the external electrodes 131 and 132 may be improved.

On the other hand, the 1-1-th electrode layer 131a and the 2-1-th electrode layer 132a may be sufficient if they cover both end surfaces of the capacitance forming portion Ac facing each other in the second direction, and thus, the ends of the 1-1-th electrode layer 131a and the 2-1-th electrode layer 132a may be disposed on the cover portions 112 and 113 and/or the margin portions 114 and 115.

In addition, the 1-2-th electrode layer 131b may be in contact with at least a portion of the third surface, and the 2-2-th electrode layer 132b may be in contact with at least a portion of the fourth surface. The bonding strength between the body 110 and the external electrodes 131 and 132 may be improved by contacting the 1-2-th electrode layer and the 2-2-th electrode layer having a relatively large area fraction of glass with the third and fourth surfaces.

The 1-1-th electrode layer 131a and the 2-1-th electrode layer 132a may be formed using, for example, an electrolytic plating method and/or an electroless plating method, and accordingly, each of the 1-1-th electrode layer 131a and the 2-1-th electrode layer 132a may be a plating layer containing at least one of Cu, Ni, Cr, Sn, and Pd. When the 1-1-th electrode layer 131a and the 2-1-th electrode layer 132a are plating layers, connectivity between the internal electrode and the external electrode may be further improved.

The 1-2-th electrode layer 131b and the 2-2-th electrode layer 132b may be formed by applying a first conductive paste containing metal and glass on the 1-1-th electrode layer 131a and 2-1-th electrode layer 132a and then sintering the same. In addition, the 1-3-th electrode layer 131c and the 2-3-th electrode layer 132c may be formed by applying and then sintering a second conductive paste containing metal and glass of a content lower than the content of the first conductive paste to the first, second, fifth, and sixth surfaces.

The metal included in the 1-2-th electrode layer 131b, the 1-3-th electrode layer 131c, the 2-2-th electrode layer 132b, and the 2-3-th electrode layer 132c may include at least one of, for example, Cu, Ni, Ag, Sn, Cr, and alloys thereof. The 1-2-th electrode layer 131b and the 1-3-th electrode layer 131c may include the same metal or different metals. In addition, the 2-2-th electrode layer 132b and the 2-3-th electrode layer 132c may include the same metal or different metals.

The average thickness t1 of the 1-1-th electrode layer 131a and the average thickness t2 of the 1-2-th electrode layer 131b do not need to be particularly limited. However, referring to FIG. 2, in an embodiment, t2>t1 may be satisfied. The 1-2-th electrode layer 131b is sufficient to serve as preventing the external moisture from penetrating into the inner electrode and the first electrode layer 131a is sufficient to secure a connectivity with the inner electrode, and therefore, the average thickness of the 1-2-th electrode layer 131b may be preferably larger than that of the first electrode layer 131a.

The t1 and t2 may be an average value of thicknesses measured at five equally spaced points in the first direction in the first and second direction cross section of the first external electrode 131 cut at the center of the body 110 in the third direction, in the image scanned with a scanning electron microscope (SEM) at a magnification of 2000 times or more. On the other hand, the five equally spaced points may be designated between extension lines of the boundary between the capacitance forming portion Ac and the cover portions 112 and 113.

Also, referring to FIGS. 5 and 7, in an embodiment, when the thickness of the 1-1-th electrode layer 131a measured at the center of the body 110 in the first direction is tm and when the thickness of the 1-1-th electrode layer 131a measured at the first or second internal electrode 121 or 122 disposed at the outermost portion of the body 110 in the first direction is tc, tc/tm may be 0.8 or more and 1.0 or less. For example, as the 1-1-th electrode layer 131a has a uniform thickness, the thickness of the 1-1-th electrode layer 131a may be relatively thin, thereby improving the capacitance per unit volume of the multilayer electronic component.

The method of controlling tc/tm to be 0.8 or more and 1.0 or less does not need to be particularly limited, and for example, by forming the 1-1-th electrode layer 131a using an electrolytic plating method and/or an electroless plating method, tc/tm may be controlled to be 0.8 or more and 1.0 or less.

The tm and tc may be measured in the image scanned with a scanning electron microscope (SEM) at a magnification of 2000 times or more, on the first and second direction cross section of the first external electrode 131 cut at the center of the body 110 in the third direction.

On the other hand, the 1-1-th electrode layer 131a may have a symmetrical relationship with the 2-1-th electrode layer 132a in the second direction, and the 1-2-th electrode layer 131b may have a symmetrical relationship with the 2-2-th electrode layer 132b in the second direction, and therefore, the descriptions of the thicknesses of the 1-1-th electrode layer 131a and the 1-2-th electrode layer 131b may be equally applied to the 2-1-th electrode layer 132a and the 2-2-th electrode layer 132b.

The 1-4-th electrode layer 131d and the 2-4-th electrode layer 132d may improve mounting characteristics. The types of the 1-4-th electrode layer and the 2-4-th electrode layer are not particularly limited, and may be plating layers including Ni, Sn, Pd, and/or alloys including the same, and may be formed of a plurality of layers.

The 1-4-th electrode layer 131d and the 2-4-th electrode layer 132d may be, for example, Ni plating layers or Sn plating layers, and may have the form in which the Ni plating layer and the Sn plating layer are sequentially formed. In addition, the 1-4-th electrode layer 131d and the 2-4-th electrode layer 132d may include a plurality of Ni plating layers and/or a plurality of Sn plating layers.

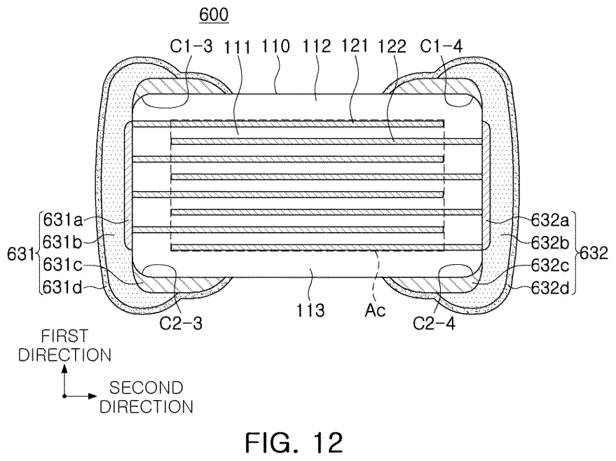

Hereinafter, various embodiments will be described with reference to FIGS. 2 and 8 to 12. As will be described later, FIGS. 2 and 8 to 10 illustrate embodiments in which the 1-2-th electrode layer and the 2-2-th electrode layer are in contact with the corner of the body, and FIGS. 11 and 12 illustrate embodiments in which the 1-3-th electrode layer and the 2-3-th electrode layer are in contact with the corner of the body.

Referring to FIG. 2, the 1-2-th electrode layer 131b is in contact with the 1-3-th corner C1-3 and the 2-3-th corner C2-3, and the 2-2-th electrode layer 132b may contact the 1-4-th corner C1-4 and the 2-4-th corner C2-4. Since the 1-2-th electrode layer and the 2-2-th electrode layer come into contact with the corner of the body, external moisture may be prevented from penetrating into the body through the corner, and may have an advantage in terms of moisture resistance.

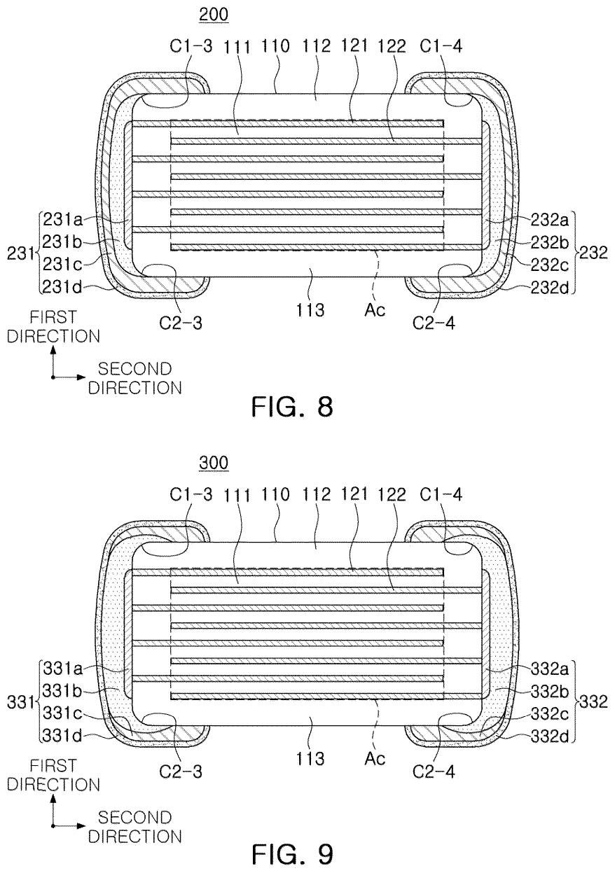

FIG. 8 is a modified example of FIG. 2. Referring to FIG. 8, a multilayer electronic component 200 according to an embodiment may include first and second external electrodes 231 and 232. The first external electrode may include a 1-1-th electrode layer 231a, a 1-2-th electrode layer 231b, a 1-3-th electrode layer 231c, and a 1-4-th electrode layer 231d, and the second external electrode may include a 2-1-th electrode layer 232a, a 2-2-th electrode layer 232b, a 2-3-th electrode layer 232c, and a 2-4-th electrode layer 232d.

In this case, the 1-3-th electrode layer 231c may be disposed on the third surface to cover the 1-2-th electrode layer 231b. Also, the 2-3-th electrode layer 232c may be disposed on the fourth surface to cover the 2-2-th electrode layer 232b.

The 1-2-th electrode layer 231b and the 2-2-th electrode layer 232b prevent penetration of external moisture into the internal electrodes 121 and 122 through the third and fourth surfaces, and the 1-3-th electrode layer 231c and the 2-3-th electrode layer 232c may be peeled off from the body 110 when an external stress exceeding a deformation range is applied. As a result, the stress applied to the body 110 may be relieved to prevent cracks from occurring.

FIG. 9 is a modified example of FIG. 2. Referring to FIG. 9, a multilayer electronic component 300 according to an embodiment includes first and second external electrodes 331 and 332. The first external electrode may include a 1-1-th electrode layer 331a, a 1-2-th electrode layer 331b, a 1-3-th electrode layer 331c, and a 1-4-th electrode layer 331d, and the second external electrode may include a 2-1-th electrode layer 332a, a 2-2-th electrode layer 332b, a 2-3-th electrode layer 332c, and a 2-4-th electrode layer 332d.

The 1-2-th electrode layer 331b may be disposed on the 1-1-th electrode layer and extend onto respective portions of the first and second surfaces, and the 1-3-th electrode layer 331c may extend onto the 1-2-th electrode layer 331b extending onto the first and second surfaces. Here, the 1-3-th electrode layer 631c may extend beyond an extension line of the third surface in the second direction.

The 2-2-th electrode layer 332b may be disposed on the 2-1-th electrode layer and extend onto respective portions of the first and second surfaces, and the 2-3-th electrode layer 332c may extend onto the 2-2-th electrode layer 332b extending onto the first and second surfaces. Here, the 2-3-th electrode layer 632c may extend beyond an extension line of the fourth surface in the second direction.

The 1-2-th electrode layer 331b and the 2-2-th electrode layer 332b prevent penetration of external moisture into the internal electrodes 121 and 122 through the third and fourth surfaces, and the 2-3-th electrode layer 331c and the 2-3-th electrode layer 332c may be peeled off from the body 110 when an external stress exceeding a deformation range is applied. As a result, the stress applied to the body 110 may be relieved to prevent cracks from occurring.

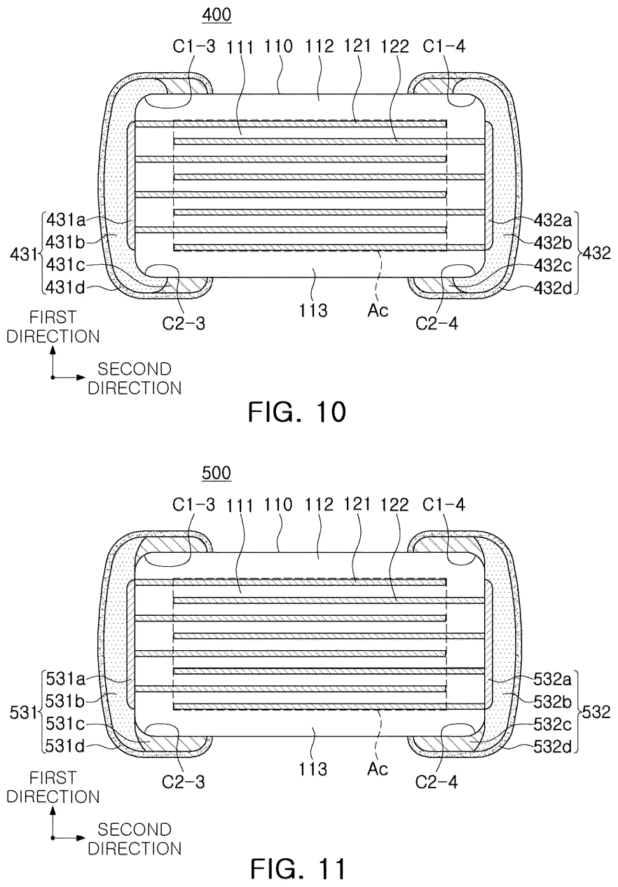

FIG. 10 is a modified example of FIG. 2. Referring to FIG. 10, a multilayer electronic component 400 according to an embodiment may include first and second external electrodes 431 and 432. The first external electrode may include a 1-1-th electrode layer 431a, a 1-2-th electrode layer 431b, a 1-3-th electrode layer 431c, and a 1-4-th electrode layer 431d, and the second external electrode may include a 2-1-th electrode layer 432a, a 2-2-th electrode layer 432b, a 2-3-th electrode layer 432c, and a 2-4-th electrode layer 432d.

The 1-2-th electrode layer 431b may be disposed on the 1-1-th electrode layer and extend onto respective portions of the first and second surfaces, and an end of the 1-2-th electrode layer 431b and an end of the 1-3-th electrode layer 431c may be in contact with each other on the first and second surfaces. Here, the end of the 1-3-th electrode layer 631c may be disposed inside of an extension line of the third surface 3 in the second direction.

The 2-2-th electrode layer 432b may be disposed on the 2-1-th electrode layer and extend onto respective portions of the first and second surfaces, and an end of the 2-2-th electrode layer 432b and an end of the 2-3-th electrode layer 432c may be in contact with each other on the first and second surfaces. Here, the end of the 2-3-th electrode layer 632c may be disposed inside of an extension line of the fourth surface 4 in the second direction.

The 1-2-th electrode layer 431b and the 2-2-th electrode layer 432b prevent external moisture from penetrating into the internal electrodes 121 and 122 through the third and fourth surfaces, and the 1-3-th electrode layer 431c and the 2-3-th electrode layer 432c may be peeled off from the body 110 when an external stress exceeding a deformation range is applied. As a result, the stress applied to the body 110 may be relieved to prevent cracks from occurring.

FIG. 11 is a modified example of FIG. 2. Referring to FIG. 11, a multilayer electronic component 500 according to an embodiment may include first and second external electrodes 531 and 532. The first external electrode may include a 1-1-th electrode layer 531a, a 1-2-th electrode layer 531b, a 1-3-th electrode layer 531c, and a 1-4-th electrode layer 531d, and the second external electrode may include a 2-1-th electrode layer 532a, a 2-2-th electrode layer 532b, a 2-3-th electrode layer 532c, and a 2-4-th electrode layer 532d.

On the other hand, the 1-3-th electrode layer 531c may contact the 1-3-th corner C1-3 and the 2-3-th corner C2-3, and the 2-3-th electrode layer 532c may contact the 1-4-th corner C1-4 and the 2-4-th corner C2-4. Since the 1-3-th electrode layer and the 2-3-th electrode layer having a relatively low area fraction of glass come into contact with the corner of the body vulnerable to penetration of the plating solution, erosion of the glass by the plating solution may be prevented.

FIG. 12 is a modified example of FIG. 2. Referring to FIG. 12, a multilayer electronic component 600 according to an embodiment includes first and second external electrodes 631 and 632, and the first external electrode may include a 1-1-th electrode layer 631a, a 1-2-th electrode layer 631b, a 1-3-th electrode layer 631c, and a 1-4-th electrode layer 631d, and the second external electrode may include a 2-1-th electrode layer 632a, a 2-2-th electrode layer 632b, a 2-3-th electrode layer 632c, and a 2-4-th electrode layer 632d.

The 1-2-th electrode layer 631b may be disposed on the 1-1-th electrode layer and extend onto a portion of the 1-3-th electrode layer 631c, and the 2-2-th electrode layer 632b may be disposed on the 2-1-th electrode layer and extend onto a portion of the 2-3-th electrode layer 632c. Here, end portions of the 1-2-th electrode layer 631b may protrude, in the first direction, more than the 1-3-th electrode layer 631c such that a groove is formed between each end portion of the 1-2-th electrode layer 631b and the 1-3-th electrode layer 631c. Similarly, end portions of the 2-2-th electrode layer 632b may protrude, in the first direction, more than the 2-3-th electrode layer 632c such that a groove is formed between each end portion of the 2-2-th electrode layer 632b and the 2-3-th electrode layer 632c.

The 1-2-th electrode layer 631b and the 2-2-th electrode layer 632b prevent penetration of external moisture into the internal electrodes 121 and 122 through the third and fourth surfaces, and the 1-3-th electrode layer 631c and the 2-3-th electrode layer 632c may be peeled off from the body 110 when an external stress exceeding a deformation range is applied. As a result, the stress applied to the body 110 may be relieved to prevent cracks from occurring.

Hereinafter, a multilayer electronic component according to another embodiment will be described. However, the multilayer electronic component according to an embodiment may have the same configuration as the above-described multilayer electronic component according to the embodiment. Therefore, description overlapping with the above-described embodiment will be omitted.

A multilayer electronic component 100 according to an embodiment may include a body 110 including a dielectric layer 111 and first and second internal electrodes 121 and 122 alternately disposed with the dielectric layer interposed therebetween, and having first and second surfaces 1 and 2 opposing each other in the first direction, third and fourth surfaces 3 and 4 connected to the first and second surfaces and opposing each other in the second direction, and fifth and sixth surfaces 5 and 6 connected to the first to fourth surfaces and opposing each other in the third direction, a first external electrode 131 including a 1-1-th electrode layer 131a disposed on the third surface, a 1-2-th electrode layer 131b disposed on the 1-1-th electrode layer, and a 1-3-th electrode layer 131c disposed on the first and second surfaces and connected to the 1-2-th electrode layer, and a second external electrode 132 including a 2-1-th electrode layer 132a disposed on the fourth surface, a 2-2-th electrode layer 132b disposed on the 2-1-th electrode layer, and a 2-3-th electrode layer 132c disposed on the first and second surfaces and connected to the 2-2-th electrode layer. The 1-1-th electrode layer 131a and the 2-1-th electrode layer 132a are plating layers each containing at least one of Cu, Ni, Cr, Sn, and Pd, the 1-2-th electrode layer 131b and the 2-2-th electrode layer 132b each include glass, the content of glass included in the 1-2-th electrode layer 131b is greater than the content of glass included in the 1-3-th electrode layer 131c, and the content of glass included in the 2-2-th electrode layer 132b may be greater than the content of glass included in the 2-3-th electrode layer 132c.

As described above, when the 1-1-th electrode layer 131a and the 2-1-th electrode layer 132a are plating layers containing at least one of Cu, Ni, Cr, Sn, and Pd, respectively, connectivity between the internal electrodes 121 and 122 and the external electrodes 131 and 132 may be further improved.

In addition, the content of glass included in the 1-2-th electrode layer 131b is greater than the content of glass included in the 1-3-th electrode layer 131c, and the content of glass included in the 2-2-th electrode layer 132b is greater than the content of glass included in the 2-3-th electrode layer 132c. Therefore, the 1-2-th electrode layer 131b and the 2-2-th electrode layer 132b may have relatively high density, and accordingly, penetration of external moisture into the internal electrodes 121 and 122 through the third and fourth surfaces may be prevented.

In addition, the 1-3-th electrode layer 131c and the 2-3-th electrode layer 132c having a relatively low glass content may be peeled off from the body 110 when an external stress exceeding the deformation range is applied. As a result, the stress applied to the body 110 is alleviated, thereby preventing cracks from occurring. In this case, the content of glass may refer to the area fraction of the glass described above.

### EXPERIMENTAL EXAMPLE

### (Moisture Resistance Reliability Evaluation Under Conditions of S1-2≥15% and S2-2≥15%)

First, after preparing a body including a dielectric layer and internal electrodes, a 1-1-th electrode layer and a 1-2-th electrode layer were formed on the third and fourth surfaces of the body using a plating method.

Thereafter, by applying a first conductive paste containing metal and glass on the 1-1-th electrode layer and the 2-1-th electrode layer and then sintering the same, a 1-2-th electrode layer and a 2-2-th electrode layer were formed. By applying a second conductive paste containing metal and glass in a smaller content than the first conductive paste to the first, second, fifth, and sixth surfaces and then sintering the same, the 1-3-th electrode layer and the 2-3-th electrode layer were formed. Thereafter, the Ni plating layer and the Sn plating layer were sequentially formed to form the 1-4-th electrode layer and the 2-4-th electrode layer, and a sample chip including first and second external electrodes was prepared.

Next, after obtaining images of cross sections of the first and second external electrodes in the first and second directions, cut at the center of the body in the third direction, with a scanning electron microscope (SEM) at 5000× magnification, S1-2, S1-3, S2-2 and S2-3-th were measured through EDS analysis. The S1-2 and S2-2 were measured in the central regions of the 1-2-th and 2-2-th electrode layers in the first direction, and the S1-3 and S2-3 were measured in the central regions of the 1-3-th electrode layer and the 2-3-th electrode layer in the second direction.

At this time, after measuring S1-2 and S2-2 for 10 samples for each test number, the average values of S1-2 and S2-2 are illustrated in Table 1 below. S1-3 and S2-3 of Test Nos. 1 to 5 in Table 1 below were fixed at 14%.

For moisture resistance reliability evaluation, 40 samples are prepared for each test number and mounted on a board, and after applying a voltage of 1 Vr for 12 hours at a temperature of 85° C. and a relative humidity of 85%, the number of samples whose insulation resistance fell by 10³Ω or more from the initial value is illustrated in Table 1 below.

TABLE 1

| | | Moisture Resistance |
|---|---|---|
| Test No. | S-2 (S2-2) | Reliability |
| 1 | 7% | 7/40 |
| 2 | 10% | 2/40 |
| 3 | 15% | 0/40 |
| 4 | 20% | 0/40 |
| 5 | 30% | 0/40 |

Referring to Test Nos. 1 and 2 of Table 1 above, it can be seen that when S1-2 and S2-2 are less than 15%, moisture resistance reliability is lowered. On the other hand, in Test Nos. 3 to 5, S1-2 and S2-2 are 15% or more, and it can be confirmed that no defect occurs in the moisture resistance reliability evaluation.

### (Moisture Resistance Reliability Evaluation Under Conditions of S1-2>S1-3 and S2-2>S2-3)

After preparing the sample chip in the same manner as the above-mentioned method, S1-2, S1-3, S2-2, and S2-3-th were measured. At this time, after measuring S1-3 and S2-3 for samples for each test number, the average value of S1-3 and the average value of S2-3 are illustrated in Table 2 below. S1-2 and S2-2 of Test Nos. 6 to 10 described in Table 1 were fixed at 15%.

The humidity resistance reliability evaluation of Table 2 below was performed in the same manner as the above-described method. In addition, 50 sample chips for each test number were observed with an optical microscope, and the number of samples in which the 1-3-th electrode layer and the 2-3-th electrode layer were peeled off from the body is listed in Table 2 below, and then 10 samples for each test number were photographed with an optical microscope or scanning electron microscope (SEM), and the number of samples with cracks in the body is listed in Table 2 below.

TABLE 2

| | | | | Moisture |
|---|---|---|---|---|
| Test | | Peel-off | Crack | Resistance |
| number | S-3 (S2-3) | Frequency | Frequency | Reliability |
| 6 | 10% | 14/50 | 0/10 | 0/40 |
| 7 | 12% | 9/50 | 0/10 | 0/40 |
| 8 | 14% | 2/50 | 0/10 | 0/40 |
| 9 | 16% | 0/50 | 3/10 | 9/40 |
| 10 | 18% | 0/50 | 5/10 | 17/40 |

Referring to test numbers 9 and 10 in Table 2, since S1-2<S1-3 and S2-2<S2-3, it can be confirmed that peel-off of the 1-2-th electrode layer and the 2-2-th electrode layer does not occur. Accordingly, the stress applied to the body could not be relieved, and cracks occurred in the body. In addition, it was confirmed that the moisture resistance reliability of the multilayer electronic component was lowered due to cracks generated in the body.

Meanwhile, in Test Nos. 6 to 8, peel-off of the 1-2-th electrode layer and the 2-2-th electrode layer occurred by satisfying S1-2>S1-3 and S2-2>S2-3, and accordingly, the stress applied to the body was relieved and no cracks occurred. As a result, it was confirmed that the moisture resistance reliability of the multilayer electronic component was excellent.

As set forth above, cracks from occurring in the body due to external stress may be prevented.

Moisture resistance reliability of multilayer electronic components may be improved.

A multilayer electronic component having excellent bonding strength between internal electrodes and external electrodes may be provided.

The present disclosure is not limited by the above-described embodiments and accompanying drawings, but is intended to be limited by the appended claims. Therefore, various forms of substitution, modification and change will be possible by those skilled in the art within the scope of the technical spirit of the present disclosure described in the claims, and this will also be said to fall within the scope of the present disclosure.

In addition, the expression ‘an embodiment’ does not indicate the same embodiment, and is provided to emphasize and describe different unique characteristics. However, the embodiments presented above are not excluded from being implemented in combination with features of another embodiment. For example, even if a matter described in one specific embodiment is not described in another embodiment, it may be understood as a description related to another embodiment, unless there is a description to the contrary or contradicting the matter in another embodiment.

In addition, expressions such as first and second are used to distinguish one component from another, and do not limit the order and/or importance of the components. In some cases, without departing from the scope of rights, a first element may be named a second element, and similarly, a second element may be named a first element.

While embodiments have been illustrated and described above, it will be apparent to those skilled in the art that modifications and variations could be made without departing from the scope of the present disclosure as defined by the appended claims.

What is claimed is:

1. A multilayer electronic component comprising:
a body including a dielectric layer and first and second internal electrodes alternately disposed with the dielectric layer interposed therebetween, and having a first surface and a second surface opposing each other in a first direction, a third surface and a fourth surface connected to the first and second surfaces and opposing each other in a second direction, and a fifth surface and a sixth surface connected to the first to fourth surfaces and opposing each other in a third direction;
a first external electrode including a 1-1-th electrode layer disposed on the third surface, a 1-2-th electrode layer disposed on the 1-1-th electrode layer and including glass, and a 1-3-th electrode layer disposed on the first and second surfaces and connected to the 1-2-th electrode layer; and
a second external electrode including a 2-1-th electrode layer disposed on the fourth surface, a 2-2-th electrode layer disposed on the 2-1-th electrode layer and including glass, and a 2-3-th electrode layer disposed on the first and second surfaces and connected to the 2-2-th electrode layer,
wherein in cross sections of the first and second external electrodes in the first and second directions, S1-2≥15%, S1-2>S1-3, S2-2≥15% and S2-2>S2-3 are satisfied, where an area fraction occupied by glass in the 1-2-th electrode layer is S1-2, an area fraction occupied by glass in the 1-3-th electrode layer is S1-3, an area fraction occupied by glass in the 2-2-th electrode layer is S2-2, and an area fraction occupied by glass in the 2-3-th electrode layer is S2-3.

2. The multilayer electronic component of claim 1, wherein the S1-3 and S2-3 satisfy S1-3≤14% and S2-3≤14%.

3. The multilayer electronic component of claim 2, wherein the S1-3 and S2-3 satisfy 0%<S1-3≤14% and 0%<S2-3≤14%.

4. The multilayer electronic component of claim 2, wherein the S1-3 and S2-3 satisfy S1-3=0% and S2-3=0%.

5. The multilayer electronic component of claim 1, wherein the S1-2 is measured in a central area of the 1-2-th electrode layer in the first-direction, and the S1-3 is measured in a central area of the 1-3-th electrode layer in the second direction, and
the S2-2 is measured in a central region of the 2-2-th electrode layer in the first direction, and the S2-3 is measured in a central region of the 2-3-th electrode layer in the second direction.

6. The multilayer electronic component of claim 1, wherein the 1-1-th electrode layer and the 2-1-th electrode layer do not contain glass.

7. The multilayer electronic component of claim 1, wherein the 1-2-th electrode layer is in contact with at least a portion of the third surface, and
the 2-2-th electrode layer is in contact with at least a portion of the fourth surface.

8. The multilayer electronic component of claim 1, comprising a 1-3-th corner connecting the first and third surfaces, a 1-4-th corner connecting the first and fourth surfaces, and a 2-3-th corner connecting the second and third surfaces, and a 2-4-th corner connecting the second and fourth surfaces, each of the 1-3-th corner, 1-4-th corner, the 2-3-th corner, and the 2-4-th corner having a round shape,
wherein the 1-2-th electrode layer is in contact with the 1-3-th corner and the 2-3-th corner, and
the 2-2-th electrode layer is in contact with the 1-4-th corner and the 2-4-th corner.

9. The multilayer electronic component of claim 1, comprising a 1-3-th corner connecting the first and third surfaces, a 1-4-th corner connecting the first and fourth surfaces, and a 2-3-th corner connecting the second and third surfaces, and a 2-4-th corner connecting the second and fourth surfaces, each of the 1-3-th corner, 1-4-th corner, the 2-3-th corner, and the 2-4-th corner having a round shape,
wherein the 1-3-th electrode layer is in contact with the 1-3-th corner and the 2-3-th corner, and
the 2-3-th electrode layer is in contact with the 1-4-th corner and the 2-4-th corner.

10. The multilayer electronic component of claim 1, wherein t2>t1 is satisfied, where an average thickness of the 1-1-th electrode layer is t1 and an average thickness of the 1-2-th electrode layer is t2.

11. The multilayer electronic component of claim 1, wherein tc/tm is 0.8 or more and 1.0 or less, where a thickness of the 1-1-th electrode layer measured at a center of the body in the first direction is tm and a thickness of the 1-1-th electrode layer measured on the first or second internal electrode disposed at an outermost portion of the body in the first direction is tc.

12. The multilayer electronic component of claim 1, wherein the first external electrode further includes a 1-4-th electrode layer disposed on the 1-2-th electrode layer and extending onto the 1-3-th electrode layer, and
the second external electrode further includes a 2-4-th electrode layer disposed on the 2-2-th electrode layer and extending onto the 2-3-th electrode layer.

13. The multilayer electronic component of claim 1, wherein the 1-1-th electrode layer, the 1-2-th electrode layer, the 1-3-th electrode layer, the 2-1-th electrode layer, the 2-2-th electrode layer, and the 2-3-th electrode layer each contain a metal.

14. The multilayer electronic component of claim 13, wherein the 1-2-th electrode layer, the 1-3-th electrode layer, the 2-2-th electrode layer, and the 2-3-th electrode layer each include at least one of Cu, Ni, Ag, Sn, Cr, or alloys thereof,
the metal contained in the 1-2-th electrode layer is the same as the metal contained in the 1-3-th electrode layer, and
the metal contained in the 2-2-th electrode layer is the same as the metal contained in the 2-3-th electrode layer.

15. The multilayer electronic component of claim 13, wherein the 1-2-th electrode layer, the 1-3-th electrode layer, the 2-2-th electrode layer, and the 2-3-th electrode layer each include at least one of Cu, Ni, Ag, Sn, Cr, or alloys thereof,
the metal contained in the 1-2-th electrode layer is different from the metal contained in the 1-3-th electrode layer, and
the metal contained in the 2-2-th electrode layer is different from the metal contained in the 2-3-th electrode layer.

16. The multilayer electronic component of claim 1, wherein an average thickness of the dielectric layer is 0.4 μm or less.

17. The multilayer electronic component of claim 1, wherein an average thickness of each of the first and second internal electrodes is 0.4 μm or less.

18. The multilayer electronic component of claim 1, wherein the S1-2 and S2-2 satisfy 15%≤S1-2≤40% and 15%≤S2-2≤40%.

19. A multilayer electronic component comprising:
a body including a dielectric layer and first and second internal electrodes alternately disposed with the dielectric layer interposed therebetween, and having a first surface and a second surface opposing each other in a first direction, a third surface and a fourth surface connected to the first and second surfaces and opposing each other in a second direction, and a fifth surface and a sixth surface connected to the first to fourth surfaces and opposing each other in a third direction;
a first external electrode including a 1-1-th electrode layer disposed on the third surface, a 1-2-th electrode layer disposed on the 1-1-th electrode layer, and a 1-3-th electrode layer disposed on the first and second surfaces and connected to the 1-2-th electrode layer; and
a second external electrode including a 2-1-th electrode layer disposed on the fourth surface, a 2-2-th electrode layer disposed on the 2-1-th electrode layer, and a 2-3-th electrode layer disposed on the first and second surfaces and connected to the 2-2-th electrode layer,
wherein the 1-1-th electrode layer and the 2-1-th electrode layer are plating layers each containing at least one of Cu, Ni, Cr, Sn, or Pd,
the 1-2-th electrode layer and the 2-2-th electrode layer each include glass,
a content of glass included in the 1-2-th electrode layer is greater than a content of glass included in the 1-3-th electrode layer, and
a content of glass included in the 2-2-th electrode layer is greater than a content of glass included in the 2-3-th electrode layer.

20. The multilayer electronic component of claim 19, wherein the 1-2-th electrode layer is in contact with at least a portion of the third surface, and
the 2-2-th electrode layer is in contact with at least a portion of the fourth surface.

21. The multilayer electronic component of claim 19, wherein the 1-3-th electrode layer is disposed on the third surface to cover the 1-2-th electrode layer, and the 2-3-th electrode layer is disposed on the fourth surface to cover the 2-2-th electrode layer.

22. The multilayer electronic component of claim 19, wherein the 1-2-th electrode layer has portions extending onto respective portions of the first and second surfaces, and the 1-3-th electrode layer extends onto the portions of the 1-2-th electrode layer extending onto the first and second surfaces, the 1-3-th electrode layer extending beyond an extension line of the third surface in the second direction, and
the 2-2-th electrode layer has portions extending onto respective portions of the first and second surfaces, and the 2-3-th electrode layer extends onto the portions of the 2-2-th electrode layer extending onto the first and second surfaces, the 2-3-th electrode layer extending beyond an extension line of the fourth surface in the second direction.

23. The multilayer electronic component of claim 19, wherein the 1-2-th electrode layer has portions extending onto respective portions of the first and second surfaces, and an end of the 1-2-th electrode layer and an end of the 1-3-th electrode layer are in contact with each other on the first and second surfaces, the end of the 1-3-th electrode layer being disposed inside of an extension line of the third surface in the second direction, and
the 2-2-th electrode layer has portions extending onto respective portions of the first and second surfaces, and an end of the 2-2-th electrode layer and an end of the 2-3-th electrode layer are in contact with each other on the first and second surfaces, the end of the 2-3-th electrode layer being disposed inside of an extension line of the fourth surface in the second direction.

24. The multilayer electronic component of claim 19, comprising a 1-3-th corner connecting the first and third surfaces, a 1-4-th corner connecting the first and fourth surfaces, and a 2-3-th corner connecting the second and third surfaces, and a 2-4-th corner connecting the second and fourth surfaces, each of the 1-3-th corner, 1-4-th corner, the 2-3-th corner, and the 2-4-th corner having a round shape,
wherein the 1-3-th electrode layer is in contact with the 1-3-th corner and the 2-3-th corner, and the 2-3-th electrode layer is in contact with the 1-4-th corner and the 2-4-th corner.

25. The multilayer electronic component of claim 24, wherein the 1-2-th electrode layer has end portions extending onto respective portions of the 1-3-th electrode layer on the first and second surfaces, and
the 2-2-th electrode layer has end portions extending onto respective portions of the 2-3-th electrode layer on the first and second surfaces.

26. The multilayer electronic component of claim 25, wherein the end portions of the 1-2-th electrode layer protrude, in the first direction, more than the 1-3-th electrode layer such that a groove is formed between each end portion of the 1-2-th electrode layer and the 1-3-th electrode layer, and
the end portions of the 2-2-th electrode layer protrude, in the first direction, more than the 2-3-th electrode layer such that a groove is formed between each end portion of the 2-2-th electrode layer and the 2-3-th electrode layer.
